(19) United States
(12) Patent Application Publication
(10) Pub. No.: US 2016/0206490 A1
(43) Pub. Date: Jul. 21, 2016

(54) SIT TO STAND FRAME

(71) Applicant: Allan PERRIAM, Melbourne, Victoria (AU)

(72) Inventor: Allan PERRIAM, Melbourne, Victoria (AU)

(21) Appl. No.: 14/912,307

(22) PCT Filed: Aug. 13, 2014
(86) PCT No.: PCT/AU2014/050182

§ 371 Date: Feb. 16, 2016

(30) Foreign Application Priority Data
Aug. 16, 2013 (AU) 2013903402
Sep. 13, 2013 (AU) 2013903533

(51) Int. Cl. A61G 7/053

(52) U.S. Cl. CPC A61G 7/053

(57) ABSTRACT

A sit to stand frame for assisting a person to move from a seated position on a side of a bed to a standing position, including left and right arm members separated by a transverse member coupled therebetween; and an anchoring section coupled to the arm members for transferring a load of the person away from the arm members to an anchoring point, wherein upper sections of the left and right arm members are supported above an upper surface of a mattress of the bed for engagement with respective left and right arms of the person seated therebetween.

### TECHNICAL FIELD OF THE INVENTION

The present invention relates to a sit to stand frame.

### BACKGROUND OF THE INVENTION

Falls present a potential increased health burden to the individual and the health care system. In-patient fails, or falls during hospitalisation are one of the leading factors in increased mortality, morbidity and delayed nine to discharge. Falls also result in an increase in healthcare costs to the broader community as a whole.

Not only do decreased mobility, functional decline and increased risk of falls present a potential danger to the health and wellbeing of the patient, but they also pose a serious threat to the health and wellbeing of the staff tasked to care for those patients.

Much research has been conducted over the past few decades and a significant amount of time and money has been spent on public health campaigns urging greater public awareness and education in falls risk reduction. Manual handling practices have evolved over the past few decades and there have been many gadgets, devices, machines and manual handling strategies employed to assist staff and carers alike care safely for their patients, clients or loved ones.

It is generally desirable to provide a device, or other apparatus, that enables patients to safely and confidently stand from a seated position on the edge of their bed with reduced risk to themselves and minimal aid from and assistant.

It is generally desirable to overcome or ameliorate one or more of the above mentioned difficulties, or at least provide a useful alternative.

### SUMMARY OF THE INVENTION

According to the present invention, there is provided a sit to stand frame for assisting a person to move from a seated position on a side of a bed to a standing position, including:

(a) left and right arm members separated by a transverse member coupled therebetween; and

(b) an anchoring section coupled to the arm members for transferring a load of the person away from the arm members to an anchoring point,

wherein upper sections of the left and right arm members are supported above an upper surface of a mattress of the bed for engagement with respective left and right arms of the person seated therebetween.

Preferably, the arm members include transmission sections coupled between said upper sections and the anchoring section, the transmission sections supporting said upper sections above the upper surface of the mattress of the bed.

Preferably, the anchoring section includes left and right posts extending downwardly from respective left and right arm members. Preferably, the left and right posts extend downwardly towards a floor or ground surface. Alternatively, the left and right posts preferably extend downwardly for engagement with a frame of the bed.

### BRIEF DESCRIPTION OF THE DRAWINGS

Preferred embodiments of the present invention are hereafter described, by way of non-limiting example only, with reference to the accompanying drawing in which:

FIG. 1 is a perspective view of a sit to stand frame;

FIG. 2 is a left side view of the sit to stand frame shown in FIG. 1;

FIG. 3 is a top view of the sit to stand frame shown in FIG. 1;

FIG. 4 is a right side view of the sit to stand frame shown in FIG. 1 fitted to a sick of a bed;

FIG. 5 is a top view of the sit to stand frame and bed shown in FIG. 4;

FIG. 6 is a left side view of the frame shown in FIG. 1 with an alternative anchoring section;

FIG. 7 is a left side view of the frame shown in FIG. 6 fitted to a bed;

FIG. 8 is a left side view of another sit to stand frame;

FIG. 9 is a left side view of the frame shown in FIG. 8 arranged in another condition of use;

FIG. 10 is a top side view of the frame shown in FIG. 8; and

FIG. 11 is an end view of the frame shown in FIG. 8.

### DETAILED DESCRIPTION OF PREFERRED EMBODIMENTS OF THE INVENTION

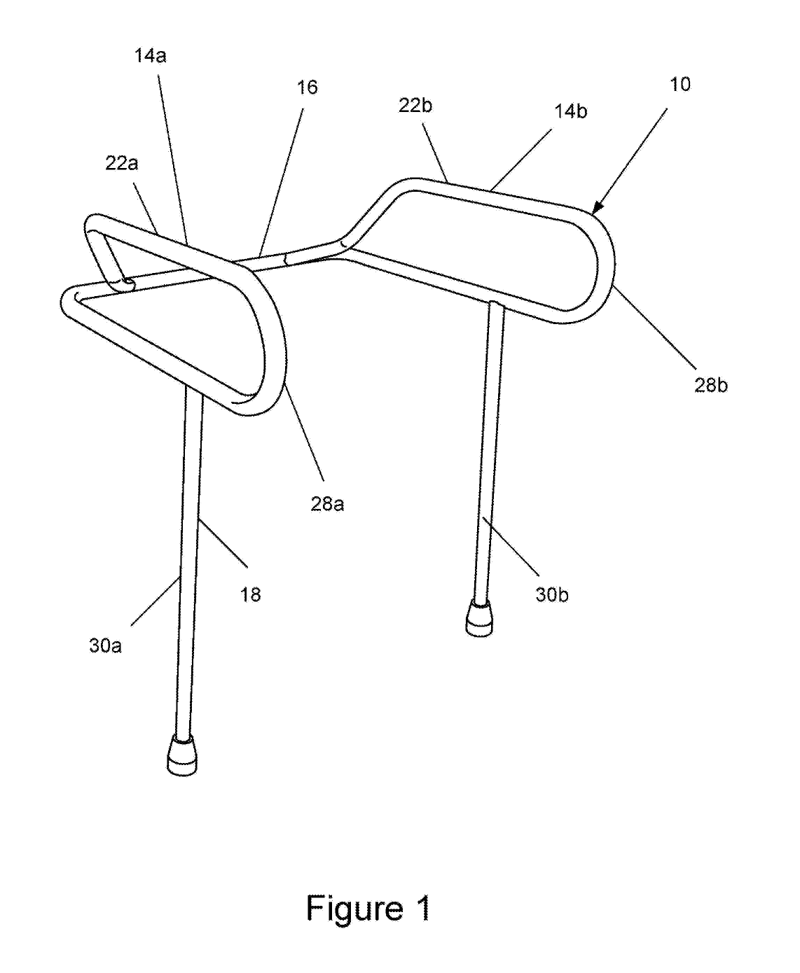

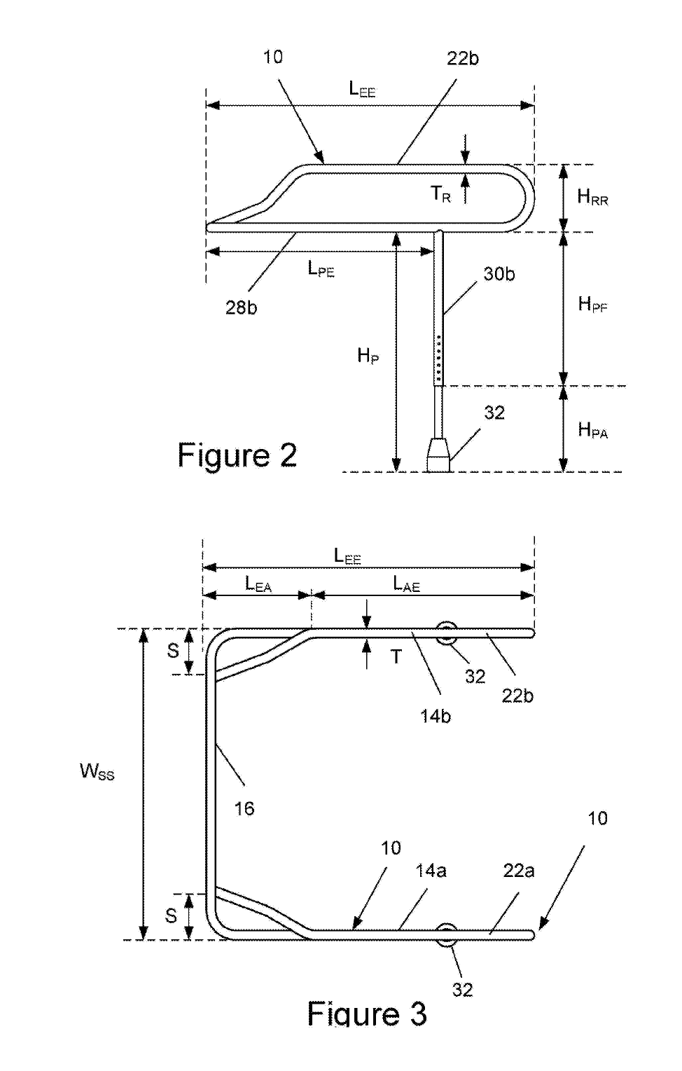

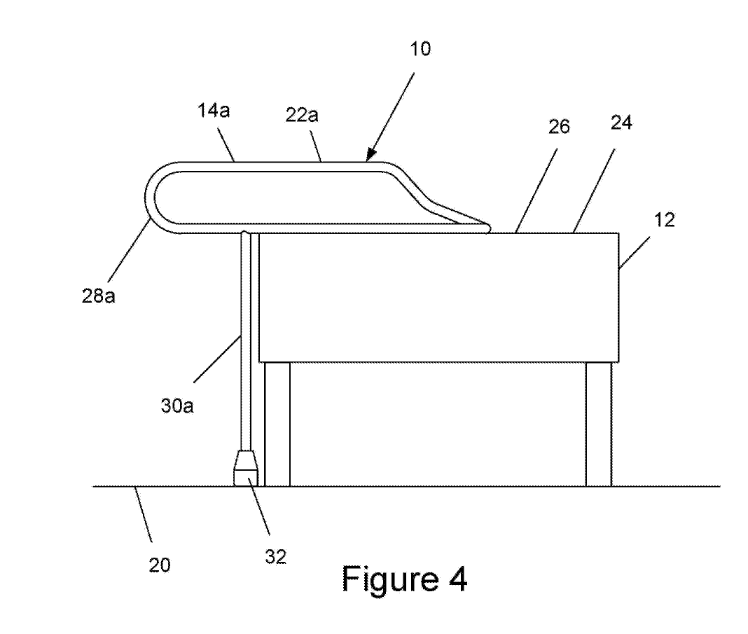

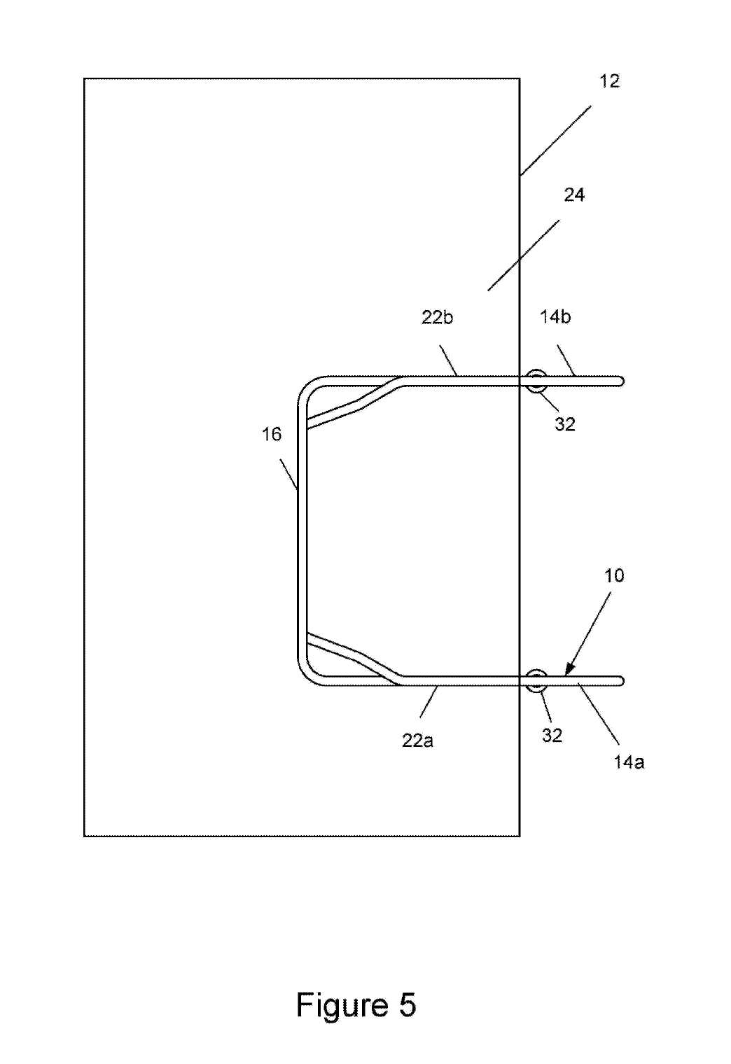

The sit to stand frame 10 shown in FIGS. 1 to 3 can be fitted to a side of a bed 12 in the manner shown in FIGS. 4 and 5. The frame 10 can be used to assist a person (not shown) to move from a seated position on a side of the bed 12 to a standing position. The frame 10 is intended for the purpose of enabling people suffering functional decline and decreased mobility (particularly leg strength and imbalance) to go safely from a seated position on the edge of a bed 12, to a standing position either independently or with the assistance of one other person. The frame 10 forms an armchair-like shape around the person whereby he or she can use the frame 10 to push themselves up into a standing position safely and with minimal aid from an assistant.

The frame 10 includes left and right arm members 14a, 14b separated by a transverse member 16 coupled therebetween. The frame 10 also includes an anchoring section 18 coupled to the arm members 14a, 14b for transferring a load of the person away from the arm members 14a, 14b to an anchoring point 20. Upper sections 22a, 22b of the left and right arm members 14a, 14b are supported above an upper surface 24 of a mattress 26 of the bed 12 for engagement with respective left and right arms (not shown) of the person seated therebetween.

The arm members 14a, 14b include transmission sections 28a, 28b coupled between the upper sections 22a, 22b and the anchoring section 18. The transmission sections 28a, 28b support the upper sections 22a, 22b of the arm members 14a, 14b above the upper surface 24 of the mattress 26 of the bed 12.

The anchoring section 18 includes left and right posts 30a, 30b extending downwardly from respective left and right arm members 14a, 14b. The left and right posts 30a, 30b extend downwardly towards the anchoring point 20, which in the example shown is floor or ground surface.

The lengths H_{P} of the left and right posts 30a, 30b are adjustable. In the example shown, each of the posts 30a, 30b is formed in upper and lower pans, whereby the lower part is of a suitable size to slide inside the corresponding upper party to shorten the overall height of the post. The lower post is locked into position with respect to the upper post by a fastener. Alternatively, the posts 30a, 30b are telescopic, or any other suitable configuration with adjustable lengths.

The left and right posts 30a, 30b each include rubber feet 32 that provide a friction surface between the frame 10 and the floor 20, reducing the risk of the frame 10 slipping.

The upper sections 22a, 22b of the arm members 14a, 14b form top handrails that allow the user to grasp the rails in the seated position then push downwards through the frame 10 and stand upright.

The frame 10 preferably has the following dimensions:

L_{EE}=650 mm

L_{AE}440 mm

L_{EA}=210 mm

L_{EE}=430 mm

L_{UU}=541 mm

T=25 mm

W_{SS}=630 mm to 670 mm

S=130 mm

H_{RR}=170 mm to 180 mm

H_{P}=491 mm to 700 mm

H_{PE}=500 mm

H_{PA}=250 mm

These dimensions are for an exemplary embodiment of the frame 10 and for the frame 100 (mentioned below) and, of course, will vary to accommodate different sized beds and different sized people.

The frame 10 is preferably made from stainless steel and aluminium tubing that is bent and welded into shape. Alternatively, the frame 10 could be made of any other suitable material and the parts could be coupled together in any other suitable manner. The left and right arm members 14a, 14b and the transverse member 16 are preferably integrally formed.

The arm members 14a, 14b and the transverse member 16 form a three-sided base that lies flat on the upper surface 24 of the mattress 26. The front side of the frame 10 is left open for patient access.

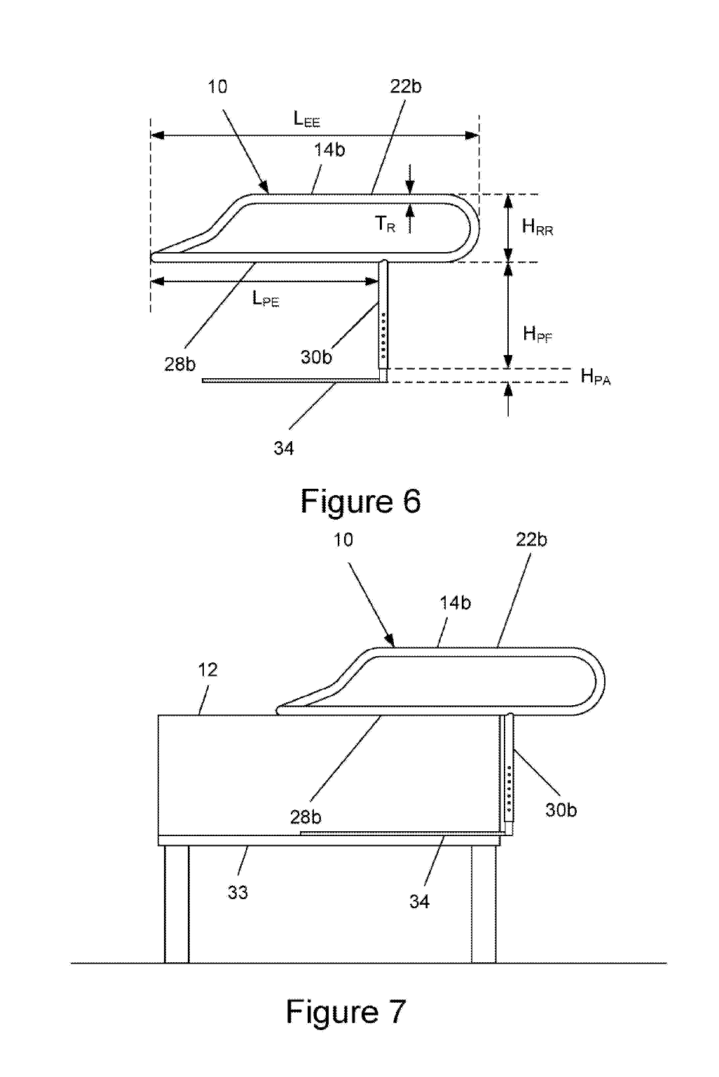

In the alternative arrangement shown in FIGS. 6 and 7, the left and right posts 30a, 30b of the frame 10 extend downwardly for engagement with a frame 33 of the bed 12. The left and right posts 30a, 30b include transverse frame engaging members 34 arranged for engagement with the frame 33 of the bed 12. In the example shown, the frame engaging members extend between the mattress 26 and the frame 34. The weight of the mattress 26 secures the frame 10 in position. Alternatively, the frame engaging members 34 are adapted to be coupled to the frame 33 of the bed with a fastener (not shown). For example, the fastener could be a clamp or a strap.

Again, the lengths H_{P} of the left and right posts 30a, 30b are adjustable. In the example shown, each of the posts 30a, 30b is formed in upper and lower parts, whereby the lower part is of a suitable size to slide inside the corresponding upper party to shorten the overall height of the post. The lower post is locked into position with respect to the upper post by a fastener, Alternatively any other suitable configuration with adjustable lengths.

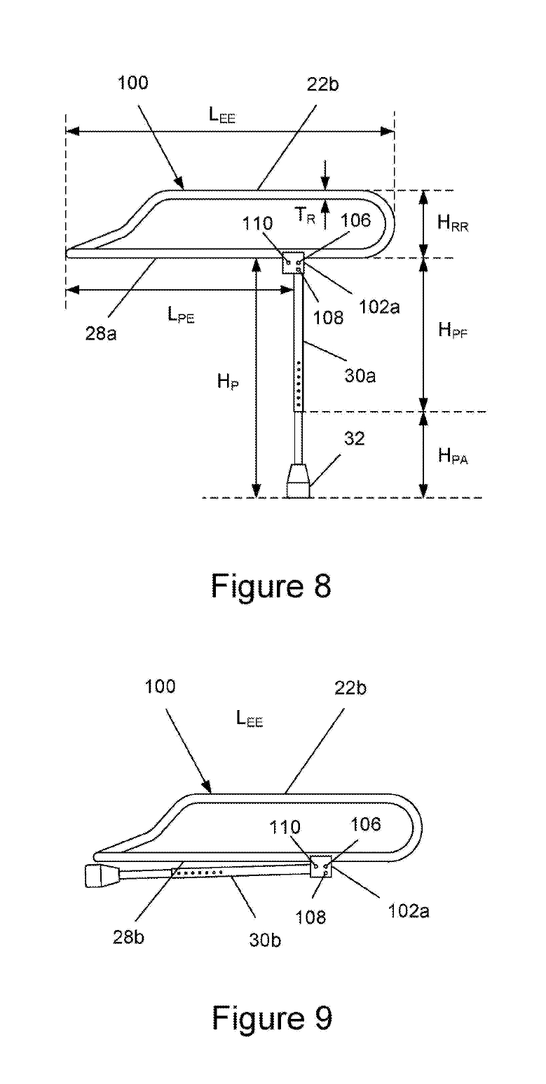

An alternative sit to stand frame 100 is shown in FIGS. 8 and 9. The alternative frame 100 includes many of the features of the frame 10 and like parts are referenced with like numbers. In addition, the frame 100 includes two hinges hinge 102a, 102b for coupling the left and right posts 30a, 30b to respective transmission sections 28a, 28b of the frame 100.

The hinges 102a, 102b each include first and second plates 104 separated by a gap. The posts 30a, 30b are shaped to fit between the plates 104 of respective hinges 102a, 102b. The posts 30a, 30b are secured to the hinges 102a, 102b pivot pins 106. The pivot pins 106 allow the posts 30a, 30b to swing between the expanded condition of use shown in FIG. 8 and the collapsed condition of use shown in FIG. 9. The posts 30a, 30b are secured in the expanded condition of use by locking pins 108, Similarly, the posts 30a, 30b are secured in the collapsed condition of use by locking pins 110. The locking pins 108 and 110 preferably extend through the plates 104 and corresponding apertures of the posts 30a, 30b. Alternatively, the locking pins 108 and 110 extend through one plate 104 and at least partially into corresponding apertures of the, posts 30a, 30b.

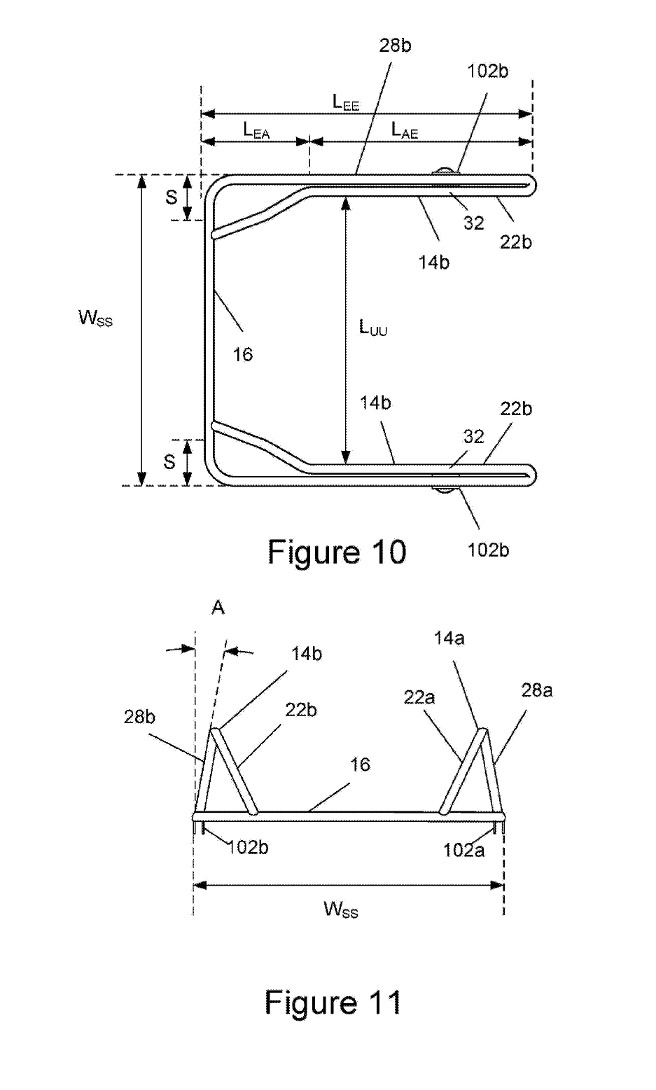

As particularly shown in FIGS. 10 and 11, upper sections 22a, 22b of the arm members 14a, 14b of the frame 100 are stepped in to improve stackability of the frames 100. To facilitate this, the arm members 14a, 14b are inclined at angle “A” from the vertical, where “A” is preferably between 10 degrees and 15 degrees. In one embodiment. “A” is 12 degrees. Of course, the angle “A” can be any other suitable angle that facilitates ease of stacking of the frames 100 one on top of the other.

Although it is not shown in the drawings, upper sections 22a, 22b of the arm members 14a, 14b of the frame 10 can also be stepped in to improve stackability of the frames 10 one on top of the other. The arm members 14a, 14b are inclined at angle “A” from the vertical, where “A” is preferably between 10 degrees and 15 degrees. “A” is preferably 12 degrees. Of course, the angle “A” can be any other suitable angle that facilitates ease of stacking of the frames 10 one on top of the other.

Many modifications will be apparent to those skilled in the art without departing from the scope of the present invention.

Throughout this specification, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference to any prior art in this specification is not, and should not be taken as, an acknowledgment or any form, of suggestion that the prior art forms part of the common general knowledge in Australia.

1. A sit to stand frame for assisting a person to move from a seated position on a side of a bed to a standing position, including:
(a) left and right arm members separated by a transverse member coupled therebetween; and
(b) an anchoring section coupled to the right and left arm members for transferring a load of the person away from the arm members to an anchoring point,
wherein upper sections of the left and right arm members are supported above an upper surface of a mattress of the bed for engagement with respective left and right arms of the person seated therebetween.

2. The frame claimed in claim 1, wherein the arm members include transmission sections coupled between said upper sections and the anchoring section, the transmission sections supporting said upper sections above the upper surface of the mattress of the bed.

3. The frame claimed in claim 1, wherein the anchoring section includes left and right posts extending downwardly from respective left and right arm members.

4. The frame claimed in claim 3, wherein the left and right posts extend downwardly towards a floor or ground surface.

5. The frame claimed in claim 4, wherein lengths of the left and right posts are adjustable.

6. The frame claim 3, wherein the left and right posts include rubber feet.

7. The frame claimed in claim 3, wherein the left and right posts extend downwardly for engagement with a frame of the bed.

8. The frame claimed in claim 7, wherein the left and right posts include transverse frame engaging members arranged for engagement with said frame of the bed.

9. The frame claimed in claim 8, wherein lengths of the left and right posts are adjustable.

10. The frame claimed in claim 3, wherein the left and right posts are coupled to the left and right arm members respective hinges so that the posts can swing between expanded and collapsed conditions of use.

11. The frame member claimed in claim 10, wherein each hinge includes first and second plates separated by a respective one of said posts and a pivot pin extending through the plates and a respective one of said posts.

12. The frame member claimed in claim 11, wherein each hinge includes a locking pin for securing a respective one of said posts in an expanded condition of use.

13. The frame member claimed in claim 12, wherein each hinge includes a locking pin for securing a respective one of said posts in a collapsed condition of use.

14. The frame claimed in claim 1, wherein upper and lower sections of the arm members are laterally displaced so that upper sections of the members are stepped in from respective lower sections.

15. The frame claimed in claim 14, wherein the arm members are inclined at angle “A” from the vertical.

16. The frame member claimed in claim 15, wherein “A” is between 10 degrees and 15 degrees.

17. The frame member claimed in claim 15, wherein “A” is 12 degrees.

18. The frame claimed in claim 1, wherein the left and right arm members and the transverse member are integrally formed.

19. The frame claimed in claim 1, wherein the arm members and the transverse member form a three-sided base that lies flat on the upper surface of the mattress.

20. The frame claimed in claim 1, wherein the upper sections of the arm members form top handrails that allow the user to grasp the rails in the seated position then push downwards through the frame and stand upright.

21. (canceled)
